(19) United States
(12) Patent Application Publication
(10) Pub. No.: US 2017/0243667 A1
(43) Pub. Date: Aug. 24, 2017

(54) ALUMINUM ALLOY ELECTRICAL WIRE AND WIRE HARNESS USING SAME

(71) Applicant: Yazaki Corporation, Tokyo (JP)

(72) Inventors: Jundai GOTO, Shizuoka (JP); Yuki YAMAMOTO, Shizuoka (JP)

(73) Assignee: Yazaki Corporation, Tokyo (JP)

(21) Appl. No.: 15/588,857

(22) Filed: May 8, 2017

Related U.S. Application Data
(63) Continuation of application No. PCT/JP2015/083982, filed on Dec. 3, 2015.

(30) Foreign Application Priority Data
Dec. 5, 2014 (JP) 2014-246422

(51) Int. Cl. H01B 1/02; H01B 7/00; H01B 5/02; C22C 21/08; C22C 21/02

(52) U.S. Cl. CPC H01B 1/023; C22C 21/08; C22C 21/02; H01B 5/02; H01B 7/0045

(57) ABSTRACT

An aluminum alloy electrical wire includes an aluminum alloy strand that is composed of an aluminum alloy including: magnesium in a range of 0.11 to 1.03 atom %; silicon in a range of 0.10 to 0.90 atom %; nickel in a range of 0.005 to 0.25 atom %; and the balance being aluminum and inevitable impurities. The aluminum alloy strand has tensile strength of 230 MPa or greater, electrical conductivity of 44% IACS or greater, and elongation of 10% or greater. A wire harness includes the aluminum alloy electrical wire.

### CROSS REFERENCE TO RELATE)) APPLICATION

This application is a Continuation of PCT Application No. PCT/JP2015/083982, filed on Dec. 3, 2015, and claims the priority of Japanese Patent Application No. 2014-246422, filed on Dec. 5, 2014, the content of all of which is incorporated herein by reference.

### BACKGROUND

1. Technical Field

The present invention relates to aluminum alloy electrical wires and wire harnesses using the same. More particularly, the present invention relates to an aluminum alloy electrical wire having high electrical conductivity, strength, and elongation, and a wire harness using the aluminum alloy electrical wire.

2. Related Art

Conventional conductor materials in electrical wires used for wire harnesses for vehicles typically include copper. In order to deal with a demand for a reduction in weight of electrical wires, aluminum is recently increasingly used for conductor materials. A reduction in diameter of aluminum electrical wires has also been advanced for a further reduction in weight of the electrical wires.

As a diameter of an aluminum electrical wire decreases, a withstand load necessary for the aluminum electrical wire inevitably decreases. Materials used for electrical wires are required to have high strength and elongation in order to absorb impacts applied to terminal connection portions of wire terminals or electrical wires themselves during the manufacture or assembly of wire harnesses. Further, when an aluminum electrical wire is used instead of a copper electrical wire, a material used for a conductor preferably has high electrical conductivity.

In order to meet the demands as described above, predetermined amounts of elements have been mixed with aluminum in conventional aluminum electrical wires. Patent Literature 1 discloses an aluminum alloy wire being composed of by mass: Mg at 0.2% to 1.5%; Si at 0.1% to 2.0%; Fe at 0.1% to 1.0%, or Fe and at least one element selected from Cu, Cr, Mn, and Zr at a total of 0.1% to 1.0%; Ti at 0.08% or less; B at 0.016% or less; and the balance including Al and impurities. The aluminum alloy wire has electrical conductivity of 40% IACS or greater, tensile strength of 150 MPa or greater, elongation of 5% or greater, a wire diameter of 0 5 mm or less, and a maximum grain size of 50 μm or less.

Patent Literature 1 : Japanese Patent No. 5155464

### SUMMARY

Patent Literature 1 is required to increase the amounts of magnesium and silicon when improving the strength of the aluminum alloy wire, but has a problem that the electrical conductivity decreases as the amounts of Mg and Si added increase.

The present invention has been made in view of the above-described conventional problems. An object of the present invention is to provide an aluminum alloy electrical wire achieving high electrical conductivity together with strength and elongation, and a wire harness using the same.

An aluminum alloy electrical wire according to a first aspect of the present invention includes an aluminum alloy strand, the aluminum alloy strand composed of an aluminum alloy including: magnesium in a range of 0.11 to 1.03 atom %; silicon in a range of 0.10 to 0.90 atom %; nickel in a range of 0.005 to 0.25 atom %; and a balance being aluminum and inevitable impurities. The aluminum alloy strand has tensile strength of 230 MPa or greater, electrical conductivity of 44% IACS or greater, and elongation of 10% or greater.

An aluminum alloy electrical wire according to a second aspect of the present invention is the aluminum alloy electrical wire according to first aspect, wherein the aluminum alloy strand is composed of the aluminum alloy including: magnesium in the range of 0.11 to 0.91 atom %; silicon in the range of 0.10 to 0.80 atom %; nickel in the range of 0.005 to 0.2 atom %; and the balance being aluminum and inevitable impurities.

A wire harness according to a third aspect of the present invention includes the aluminum alloy electrical wire according to the first or second aspect.

### BRIEF DESCRIPTION OF DRAWINGS

FIG. 1 is a graph showing a relationship between electrical conductivity of an aluminum alloy and a proportion of each element mixed with aluminum in the aluminum alloy.

### DETAILED DESCRIPTION

An embodiment of the present invention will be described in detail below.

### [Aluminum Alloy Electrical Wire and Wire Harness]

An aluminum alloy electrical wire according to the present embodiment includes a strand of an aluminum alloy including aluminum as a base material and predetermined elements mixed with aluminum.

When aluminum is mixed with magnesium and silicon, these elements are bonded and deposited in an aluminum parent phase, so as to increase the intensity of the aluminum alloy. At the same time, toughness such as elongation and electrical conductivity decrease as the amounts of magnesium and silicon added increase. The present embodiment examined the fourth element for improving electrical conductivity, strength, and elongation while contributing to decreasing the amounts of magnesium and silicon mixed with aluminum.

First, as the fourth element, elements were selected capable of promoting a deposition reaction when dissolved in the aluminum parent phase so as to distort a host lattice, namely capable of increasing the strength in association with the increase of deposition density. In particular, elements having atomic radii, each of which is within ±15% of the atomic radius of aluminum, were selected. The atomic radii of the elements used are ion radii defined by Goldschmidt (metallic bond radii). Table 1 shows atomic radii of the elements and differences in atomic radius between aluminum and the respective elements. According to Table 1, the elements having atomic radii within ±15% of the atomic radius of aluminum are chromium (Cr), iron (Fe), nickel (Ni), copper (Cu), zinc (Zn), and silver (Ag).

TABLE 1

| | | Difference in atomic radius |
|---|---|---|
| | Atomic Radius* | between aluminum and element (%) |
| Element | (Å) | (dissolved when within ±15%) |
| Al | 1.43 | — |
| Cr | 1.25 | −13 |
| Mn | 1.12 | −22 |
| Fe | 1.24 | −13 |
| Ni | 1.25 | −13 |
| Cu | 1.28 | −10 |
| Zn | 1.33 | −7 |
| Ag | 1.44 | 1 |
| Sn | 2.80 | 96 |

*Goldschmidt radius = metallic bond radius

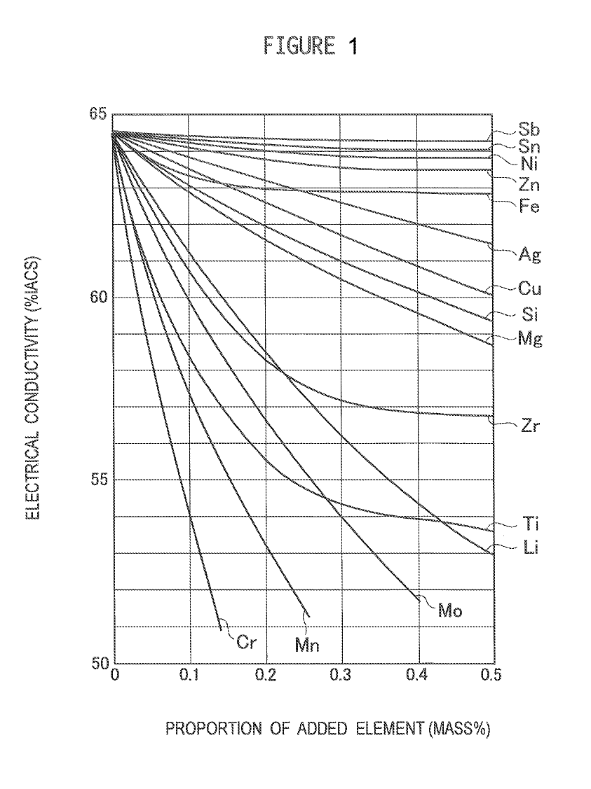

Next, elements exerting influence on electrical conductivity when mixed with aluminum were investigated. FIG. 1 is a graph showing a relationship between the electrical conductivity of the aluminum alloy in which aluminum is mixed with the respective elements and the proportion of the respective elements added (source: Development of Aluminum Alloy Conductor with High Electrical Conductivity and Controlled Tensile Strength and Elongation: Hitachi Cable Review, Volume No. 25, pp. 31-34). As shown in FIG. 1, antimony (Sb), tin (Sn), and nickel (Ni) are preferable since the electrical conductivity hardly decreases when the amount of these elements increases. However, since antimony is an environmental hazardous substance, nickel was chosen as the fourth element in view of the difference in atomic radius between aluminum and the element and the influence on the environment. Accordingly, the present invention was accomplished by analyzing the composition of the aluminum alloy capable of achieving higher strength when increasing the amount of nickel without degradation of the electrical conductivity.

The aluminum alloy electrical wire according to the present embodiment includes an aluminum alloy strand. The aluminum alloy strand is composed of an aluminum alloy including magnesium (Mg), silicon (Si), nickel (Ni), and the balance being aluminum and inevitable impurities. The aluminum alloy strand preferably consists of magnesium (Mg), silicon (Si), nickel (Ni), and aluminum and inevitable impurities.

Aluminum as a base material is preferably pure aluminum with a purity of 99.7% by mass or greater. Among the aluminum ingots prescribed in JIS H2102, Al 99.70 or greater is preferably used. Particular examples of aluminum ingots having the purity of 99.7% by mass or greater include Al 99.70, Al 99.94, Al 99.97, Al 99.98, Al 99.99, Al 99.990, and Al 99.995. The present embodiment may use not only the aluminum ingot of Al 99.995 with a high price and a high purity but also the aluminum ingot with the purity of 99.7% by mass with a reasonable price.

Magnesium (Mg) is bonded to silicon and deposited in the aluminum parent phase, so as to increase the strength of the aluminum alloy strand. However, as the amount of magnesium increases, the electrical conductivity and toughness of the resulting aluminum alloy tend to decrease. In view of this, the aluminum alloy preferably includes magnesium in the range of 0.11 to 1.03 atom %, more preferably in the range of 0.11 to 0.91 atom %.

Silicon (Si) is bonded to magnesium and deposited in the aluminum parent phase, so as to increase the strength of the aluminum alloy strand. As the amount of silicon increases, the electrical conductivity and toughness of the resulting aluminum alloy tend to decrease. Thus, the aluminum alloy preferably includes silicon in the range of 0.10 to 0.90 atom %, more preferably in the range of 0.10 to 0.80 atom %.

The present embodiment uses nickel (Ni) capable of achieving higher strength when the deposition density increases, while contributing to decreasing the amounts of magnesium and silicon added. The increased amount of nickel hardly decreases the electrical conductivity of the resulting aluminum alloy as described above, but tends to decrease the toughness. Thus, the aluminum alloy preferably includes nickel in the range of 0.005 to 0.25atom %, more preferably in the range of 0.005 to 0.2 atom %.

The amount of each of magnesium, silicon, and nickel described above includes the amount of each element originally included in the aluminum ingot as a base material, and does not necessarily denote the amount of each element added.

The aluminum alloy used in the present embodiment includes, other than magnesium, silicon, and nickel described above, the balance including aluminum and inevitable impurities. Examples of inevitable impurities which may be included in the aluminum alloy include iron (Fe), copper (Cu), titanium (Ti), gallium (Ga), zinc (Zn), boron (B), vanadium (V), zirconium (Zr), manganese (Mn), lead (Pb), calcium (Ca), and cobalt (Co). These elements may be inevitably included in the aluminum alloy without inhibiting the effects of the present embodiment or exerting any particular influence on the characteristics of the aluminum alloy of the present embodiment. The inevitable impurities include elements which may be originally contained in a pure aluminum ingot used. The total amount of the inevitable impurities included in the aluminum alloy is preferably 0.15 atom % or less, more preferably 0.12 atom % or less.

The aluminum alloy strand included in the aluminum alloy electrical wire according to the present embodiment preferably has tensile strength of 230 MPa or greater, electrical conductivity of 44% IACS or greater, and elongation of 10% or greater. The aluminum alloy strand having the tensile strength and the elongation as described above improves the mechanical strength and hardly causes breaking of the electrical wire during installation or after installation in a vehicle, and further allows the electrical wire to be installed around a position at which the electrical wire is repeatedly bent, such as hinges on a door of the vehicle. The electrical wire having the electrical conductivity of 44% IACS or greater is appropriate for use in vehicles. The tensile strength, the electrical conductivity, and the elongation may be measured in accordance with Japanese Industrial Standards JIS C3002 (Testing methods of electrical copper and aluminum wires).

The aluminum alloy electrical wire according to the present embodiment includes, as a conductor, the aluminum alloy strand composed of the aluminum alloy. As used herein, the phrase “including the aluminum alloy strand” is meant to encompass not only the inclusion as a solid conductor but also the inclusion as a stranded conductor in which a plurality of strands (3 to 1500 strands, for example, 7 strands) are braided together. The aluminum alloy electrical wire, in general, includes a plurality of aluminum alloy strands in the form of a stranded conductor.

The electrical wire as used herein is a covered wire in which a bare stranded conductor is covered with an optional insulating polymer layer. A wire harness is obtained such that a plurality of electrical wires is braided together and assembled with an outer sheath. The aluminum alloy electrical wire according to the present embodiment is only required to include a conductor including a strand composed of the aluminum alloy described above, and a cover layer (an insulating polymer layer) covering the conductor. The other specific structures, shapes and manufacturing methods are not particularly limited.

The polymer used for the cover layer may be known electrically insulating polymer optionally selected, and examples thereof include olefin polymer such as cross-linked polyethylene and polypropylene, and vinylidene chloride. The thickness of the cover layer may be determined as appropriate. The aluminum alloy electrical wire may be applicable to various purposes such as electrical or electronic components, machine components, components for vehicles, and construction materials. The aluminum alloy electrical wire may particularly preferably be used for vehicles.

A wire harness according to the present embodiment includes the aluminum alloy electrical wire described above. The aluminum alloy electrical wire according to the present embodiment can ensure significantly higher strength and electrical conductivity than conventional wires as described above, so as to achieve a reduction in diameter of the aluminum wire and broaden the applications in various parts. The wire harness including the aluminum alloy electrical wire can achieve a reduction in weight and ensure high strength, durability, and electrical conductivity, and is therefore appropriate for use in vehicles.

### [Method of Manufacturing Aluminum Alloy Electrical Wire]

A method of manufacturing the aluminum alloy electrical wire according to the present embodiment will be described below.

### <Aluminum Alloy Wire Rod>

An aluminum alloy wire rod is a wire material obtained by subjecting an aluminum alloy itself or a raw material thereof to melting/die casting and roughly drawing the aluminum alloy. The aluminum alloy used may have the same composition as the aluminum alloy used in the aluminum alloy strand included in the aluminum alloy electrical wire according to the present embodiment. The rough drawing of the aluminum alloy may be performed by any known method.

The aluminum alloy wire rod commonly has a circular shape or a polygonal shape such as a triangle and a square in cross section. The cross-sectional size, for example, the diameter when the wire rod has a circular shape in cross section, is in the range of 5 mm to 30 mm, preferably in the range of 7 mm to 15 mm.

The aluminum alloy wire rod is used as a raw material in the following solution treatment step.

### <Solution Treatment Step>

The solution treatment is a step of uniformly dissolving, into the aluminum parent phase, the elements included in the wire material before subjected to solution treatment and not yet sufficiently dissolved in the aluminum parent phase. The solution treatment may be performed under any known conditions.

### <Final Wire Drawing Step>

The final wire drawing is a step of subjecting the wire material obtained by the solution treatment to wire drawing processing so as to have a final wire diameter. The wire drawing in the final wire drawing step is performed by a known dry drawing method or wet drawing method. The final drawn wire material thus obtained commonly has a circular shape in cross section. The wire diameter (φ) of the final drawn wire material is, for example, in the range of 0.1 mm to 0.5 mm, preferably in the range of 0.15 mm to 0.35 mm.

### <Wire Stranding Step>

The wire stranding is a step of braiding together a plurality of final drawn wire materials obtained by the final wire drawing.

### <Current-Induced Annealing Step>

The current-induced annealing is a step of inducing current in the stranded conductor obtained by the wire stranding for 0.3 seconds at 12000 J/sec·cm².

The annealing in this step is continuous annealing for subjecting the moving stranded conductor to annealing treatment. In the method of manufacturing the aluminum alloy electrical wire according to the present embodiment, the continuous annealing is a key step in which the annealing is performed for a very short period of time, thereby producing a supersaturated solid solution having fine crystalline particles, so as to increase the tensile strength and the elongation of the aluminum alloy strand subjected to aging treatment described below. The continuous annealing is available in this step, since the time of annealing is as short as 0.3 seconds.

The continuous annealing is continuous current-induced thermal treatment, for example. The continuous current-induced thermal treatment is a step of passing the stranded conductor continuously through two disk electrodes and inducing current in the stranded conductor to generate Joule heat, so as to continuously anneal the stranded conductor with the generated heat.

The annealed stranded conductor thus obtained has substantially the same composition as the stranded conductor before annealing, but part of or all of processing strain inside thereof is removed to produce recrystallized grains, so as to provide appropriate flexibility to the stranded conductor. The annealed stranded conductor is used as a raw material in the following aging treatment step.

### <Aging Treatment Step>

The aging treatment is a step of subjecting the stranded conductor obtained by the current-induced annealing to aging treatment for two hours at 175° C. The aging treatment causes precipitates in the crystalline particles in the aluminum alloy, so as to lead to age hardening of the annealed stranded conductor. The stranded conductor subjected to the aging treatment results in an aluminum alloy stranded conductor included in the aluminum alloy electrical wire according to the present embodiment. Each strand included in the aluminum alloy stranded conductor is the aluminum alloy strand included in the aluminum alloy electrical wire according to the present embodiment.

Typically, a method of manufacturing an aluminum alloy stranded conductor implements wire drawing, solution treatment, and aging treatment in this order. The method of manufacturing the aluminum alloy electrical wire according to the present embodiment implements the solution treatment, the final wire drawing, the wire stranding, the current-induced annealing, and the aging treatment in this order. Namely, the method of manufacturing the aluminum alloy electrical wire according to the present embodiment includes the final wire drawing step, the wire stranding step, and the current-induced annealing step after the solution treatment step. The aluminum alloy stranded conductor is obtained by the method of manufacturing the aluminum alloy electrical wire through the steps as described above, so that the aluminum alloy strand included in the aluminum alloy stranded conductor has appropriate strength and elongation.

The aluminum alloy stranded conductor thus obtained is used as a raw material of the aluminum alloy electrical wire. A method of finishing the aluminum alloy electrical wire using the aluminum alloy stranded conductor manufactured by the manufacturing method according to the present embodiment may be any known method.

The aluminum alloy electrical wire according to the present embodiment includes the aluminum alloy strand that is composed of the aluminum alloy including Mg in the range of 0.11 to 1.03 atom %, Si in the range of 0.10 to 0.90 atom %, Ni in the range of 0.005 to 0.25atom %, and the balance being aluminum and inevitable impurities. The aluminum alloy strand has the tensile strength of 230 MPa or greater, the electrical conductivity of 44% IACS or greater, and the elongation of 10% or greater. The aluminum alloy electrical wire according to the present embodiment includes nickel as the fourth element added to the Al—Mg—Si alloy. Accordingly, the aluminum alloy electrical wire can achieve higher strength than Al—Mg—Si alloy wires without degradation of the electrical conductivity. As described above, the aluminum alloy strand has the tensile strength of 230 MPa or greater and the elongation of 10% or greater. Due to the tensile strength and the elongation described above, the aluminum alloy electrical wire having resistance to overload applied during the manufacture or assembly of the wire harness and resistance to bending deformation upon opening and closing of a door, can be obtained.

The aluminum alloy strand in the aluminum alloy electrical wire according to the present embodiment more preferably includes the aluminum alloy including Mg in the range of 0.11 to 0.91 atom %, Si in the range of 0.10 to 0.80 atom %, Ni in the range of 0.005 to 0.2 atom %, and the balance including aluminum and inevitable impurities. If each of magnesium, silicone, and nickel is excessively added to the aluminum parent phase beyond solid solubility limits, coarse crystallized grains, namely aggregations of the elements added are generated in the aluminum alloy, which may lead to a reduction in elongation. The aluminum alloy including magnesium, silicone, and nickel within the ranges described above can improve the elongation performance.

### EXAMPLES

The present invention will be described in more detail below with reference to examples and comparative examples, but not intended to be limited to the examples.

### [Preparation of Test Pieces]

Each of aluminum alloys having compositions as indicated in Table 2 was obtained by use of Al 99.7 prescribed in JIS H2102 to which magnesium, silicon, and nickel were added in amounts shown in FIG. 2. Each aluminum alloy was dissolved by a regular method and roughly drawn to prepare a wire rod having a wire diameter of 9.5 mm by a continuous casting-rolling method.

The aluminum alloy wire rod was subjected to solution treatment for 0.5 hours at 550° C. to obtain a solution-treated wire material (the solution treatment step). Next, the solution-treated wire material was drawn by a continuous wire drawing machine to obtain a final drawn wire material with a final diameter of φ 0.32 mm (the final wire drawing step). A plurality of final drawn wire materials obtained was stranded by a wire stranding machine to obtain a stranded conductor with a cross-sectional area of 0.5 mm² (the wire stranding step). Subsequently, the stranded conductor was subjected to current-induced annealing for 0.3 seconds at 12000 J/sec·cm² to obtain an annealed stranded wire (the current-induced annealing step). Thereafter, the annealed stranded conductor was subjected to aging treatment for two hours at 175° C. (the aging treatment step), so as to obtain an aluminum alloy stranded conductor of each example.

### [Evaluation]

The aluminum alloy stranded conductor thus obtained was disassembled to extract an aluminum alloy strand, and the tensile strength (Ts), the elongation (El), and the electrical conductivity (% IACS) of the aluminum alloy strand were measured in accordance with JIS C3002. The electrical conductivity was calculated by measuring a specific resistance in a thermostatic bath at a constant temperature of 20° C. (±0.5° C.) by a four-point probe method. The distance between probes was set to 1000 mm. The tensile strength was measured at a tensile speed of 50 mm/min. The test piece with the tensile strength of 230 MPa or greater, the electrical conductivity of 44% IACS or greater, and the elongation of 10% or greater was evaluated as “A”. The test piece with the tensile strength of less than 230 MPa, the electrical conductivity of less than 44% IACS, and the elongation of less thanl0% was evaluated as “B”. Table 2 summarizes the results thus obtained.

TABLE 2

| | | | | Property | | | |
|---|---|---|---|---|---|---|---|
| | Aluminum Alloy Composition | | | Tensile | | Electrical | |
| | Mg | Si | Ni | Strength Ts | Elongation El | Conductivity Ec | |
| No. | (atom %) | (atom %) | (atom %) | (MPa) | (%) | (% IACS) | Evaluation |
| 1 | 0.34 | 0.30 | 0.000 | 207 | 14 | 55 | B |
| 2 | 0.34 | 0.30 | 0.050 | 240 | 14 | 56 | A |
| 3 | 0.57 | 0.50 | 0.050 | 292 | 11 | 51 | A |
| 4 | 0.91 | 0.80 | 0.005 | 294 | 10 | 45 | A |
| 5 | 1.03 | 0.90 | 0.005 | 304 | 10 | 44 | A |
| 6 | 1.14 | 1.00 | 0.005 | 313 | 9 | 43 | B |
| 7 | 0.11 | 0.10 | 0.200 | 254 | 16 | 62 | A |
| 8 | 0.11 | 0.10 | 0.250 | 287 | 12 | 63 | A |
| 9 | 0.11 | 0.10 | 0.300 | 319 | 8 | 63 | B |

According to Table 2, the test pieces Nos. 2 to 5, 7 and 8 showed preferable tensile strength, elongation, and electrical conductivity. The test piece No. 1 containing the significantly small amount of nickel resulted in insufficient tensile strength. The test piece No. 6 excessively containing magnesium and silicon resulted in insufficient electrical conductivity. The test piece No. 9 excessively containing nickel resulted in insufficient elongation.

The aluminum alloy electrical wire according to the present invention includes the aluminum alloy strand in which nickel is added as the fourth element to the Al—Mg—Si alloy. The aluminum alloy electrical wire can therefore achieve higher strength than Al—Mg—Si alloy wires without degradation of electrical conductivity. The aluminum alloy strand exhibits significantly higher strength and electrical conductivity than conventional strands, so as to achieve a reduction in diameter of the aluminum wire and broaden the applications in various parts, and further contribute to a reduction in weight of a wire harness.

While the present invention has been described above by reference to the examples, the present invention is not intended to be limited to the descriptions thereof, and various modifications will be apparent to those skilled in the art within the scope of the present invention. For example, the aluminum alloy strand described above may be applicable to not only electrical wires but also conductors for cables.

What is claimed is:

1. An aluminum alloy electrical wire comprising an aluminum alloy strand,
the aluminum alloy strand composed of an aluminum alloy including:
magnesium in a range of 0.11 to 1.03 atom %;
silicon in a range of 0.10 to 0.90 atom %;
nickel in a range of 0.005 to 0.25 atom %; and
a balance being aluminum and inevitable impurities,
the aluminum alloy strand having tensile strength of 230 MPa or greater, electrical conductivity of 44% IACS or greater, and elongation of 10% or greater.

2. The aluminum alloy electrical wire according to claim 1, wherein the aluminum alloy strand is composed of the aluminum alloy including:
magnesium in the range of 0.11 to 0.91 atom %;
silicon in the range of 0.10 to 0.80 atom %;
nickel in the range of 0.005 to 0.2 atom %; and
the balance being aluminum and inevitable impurities.

3. A wire harness comprising the aluminum alloy electrical wire according to claim 1.
